(19) United States
(12) Patent Application Publication
(10) Pub. No.: US 2022/0405673 A1
(43) Pub. Date: Dec. 22, 2022

(54) INFORMATION PROCESSING APPARATUS AND COMPUTER-READABLE STORAGE MEDIUM

(71) Applicant: HONDA MOTOR CO., LTD., Tokyo (JP)

(72) Inventors: Kojiro TAKASU, Tokyo (JP); Manato KUWABARA, Tokyo (JP); Masaki HAGIWARA, Tokyo (JP)

(21) Appl. No.: 17/897,194

(22) Filed: Aug. 28, 2022

Related U.S. Application Data
(63) Continuation of application No. PCT/JP2020/013046, filed on Mar. 24, 2020.

(51) Int. Cl. G06Q 10/06; G06Q 30/06

(52) U.S. Cl. CPC G06Q 10/06315; G06Q 30/0645

(57) ABSTRACT

An information processing apparatus is provided that generates use plan information of batteries for performing each step included in tasks by electrical machines capable of sharing batteries. The apparatus stores a number of batteries to be used for each type of the machine, a battery duration for each type of the machine, and a time required for charging the battery, receives a working schedule including a procedure of the steps, a time required for each of the steps, and types and numbers of machines used in each of the steps, and generates, based on the input information, use plan information of batteries including the number of the batteries required for the series of tasks and charging timings of the batteries.

### CROSS-REFERENCE TO RELATED APPLICATION(S)

This application is a continuation of International Patent Application No. PCT/JP2020/013046 filed on Mar. 24, 2020, the entire disclosure of which is incorporated herein by reference.

### TECHNICAL FIELD

The present invention relates to an information processing apparatus and a program.

### BACKGROUND ART

In the construction industry, the landscaping industry, the manufacturing industry, and the like, there are work sites in which a plurality of types of working machines cooperate (see, for example, PTL 1). An electrical working machine in which battery performance is improved while noise, emissions, and the like added to the environment are minimized has been proposed (see, for example, PTL 2).

### CITATION LIST

### Patent Literature

PTL 1: WO 2015/065251 A1
PTL 2: EP 2857587 B1

### SUMMARY OF INVENTION

### Technical Problem

However, in an electrical working machine, a shape and a specification of a battery (that is, a cell) to be used are usually different for each type of working machine, and the battery can be shared only between working machines of the same type. Therefore, attempts have not been made to improve battery use efficiency.

Further, when batteries are shared regardless of types of working machines, the batteries can be expected to be able to be shared among different types of working machines, leading to more efficient use of the batteries.

The present invention has been made in view of the above examples of the related art, and an objective of the present invention is to provide an efficient battery use plan based on a working schedule using an electrical working machine. Furthermore, another objective is to estimate a budget with high accuracy when a battery is rented based on a use plan.

### Solution to Problem

To achieve the above objectives, the present invention is configured as follows. According to the first aspect, there is provided an information processing apparatus that generates use plan information of batteries for performing each step included in a series of tasks by electrical working machines capable of sharing batteries, the information processing apparatus comprising: at least one memory which stores at least one program; and at least one processor, wherein the at least one program causes the at least one processor to perform: storing a number of batteries to be used for each type of the working machine, a battery duration for each type of the working machine, and a time required for charging the battery; receiving, as input information, a working schedule including a procedure of the steps, a time required for each of the steps or a power amount required for each of the steps, and types and numbers of working machines used in each of the steps; and generating, based on the input information, use plan information of batteries including the number of the batteries required for the series of tasks and charging timings of the batteries.

According to the second aspect, there is provided an information processing apparatus that estimates a rental fee of batteries for performing each step included in a series of tasks by electrical working machines that share batteries, the information processing apparatus comprising: at least one memory which stores at least one program; and at least one processor, wherein the at least one program causes the at least one processor to perform: storing a number of batteries to be used for each type of the working machine, a battery duration for each type of the working machine, a time required for charging the battery, and a rental unit price of the battery; and receiving, as input information, a working schedule including a procedure of the respective steps, a time required for the respective steps or a power amount required for the respective steps, and a type and a number of the working machines used in the respective steps; and determining the number of batteries required for the series of tasks based on the input information, and generating estimation information of the rental fee based on the number of batteries and the rental unit price.

### Advantageous Effects of Invention

According to the present invention, it is possible to provide an efficient battery use plan based on a working schedule using an electrical working machine. Further, it is possible to estimate a budget with high accuracy when a battery is rented based on the use plan.

### BRIEF DESCRIPTION OF DRAWINGS

FIG. 1A is a diagram schematically illustrating a battery rental system according to an embodiment.

FIG. 1B is a diagram illustrating an example of a working machine according to the embodiment.

FIG. 1C is a diagram illustrating an example of a configuration of the working machine according to an embodiment.

FIG. 2 is a block diagram illustrating an example of an information processing apparatus for determining a battery use plan according to the embodiment.

FIG. 3 is a flowchart of a procedure for determining the battery use plan according to the embodiment.

FIG. 4 is a flowchart of a procedure for determining the battery use plan according to the embodiment.

FIG. 5 is a flowchart of a procedure for determining the battery use plan according to the embodiment.

FIG. 6A is a diagram illustrating an example of battery use plan information according to the embodiment.

FIG. 6B is a diagram illustrating an example of battery use plan information according to the embodiment.

FIG. 7 is a flowchart of a procedure of estimating or billing a price according to the embodiment.

FIG. 8 is a flowchart of a procedure for warning of a deviation between an actual situation and a plan according to a modification of the embodiment.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

Overview of System

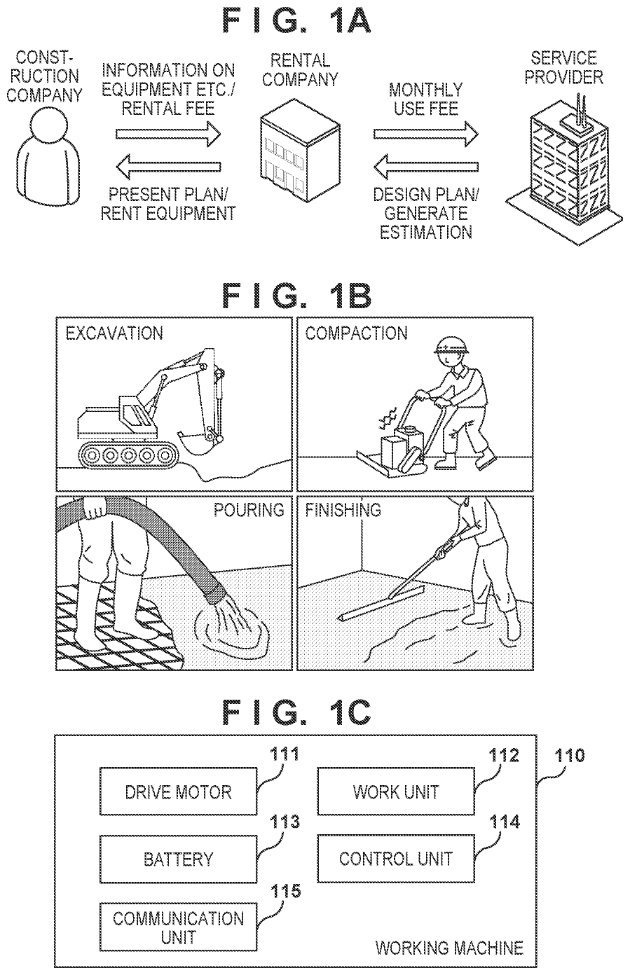

In the present embodiment, the building industry will be described as an example. FIG. 1A illustrates an example of a business model. A building company rents batteries required for driving electrical working machines and chargers as necessary from a rental company. Batteries (that is, cells) used in working machines have the same form and the same specification, and can be shared by a plurality of types of working machines. In rental, the building company requests the rental company to estimate a budget of the rental, and the rental company requests the estimation of the batteries again from a service provider. The service provider generates a use plan (or a use schedule) of the batteries in response to the request, and provides the generated use plan and the estimated budget to a rental dealer. The rental company proposes a battery use plan and an estimated amount to the building company. The building company pays a rental fee to the rental company as a price of a service, and the rental company pays a service fee to the service provider, for example, as a monthly use fee. An information processing apparatus provided by the service provider may be purchased or rented by a rental dealer, so that the rental dealer generates a use plan and an estimate of the batteries, and the rental dealer may pay a price for the service, for example, as a monthly use fee to the service provider. In the present embodiment, generation of a use plan and an estimate of batteries by a service provider will be mainly described. The service provider may be a vendor that sells batteries or a manufacturer that manufactures and sells batteries. In addition, the service provider is not independent, and the rental dealer may also serve as the service provider. In this case, a price for a battery use plan information generation service may not be generated. In the present embodiment, the service provider prepares its own information processing apparatus, but it may provide a service as a web application using, for example, a cloud server. In this case, the rental dealer may serve as a client and may be provided with a service through a web browser.

FIG. 1B illustrates an example of a working machine used in each step of slab-on-grade concrete construction as an example of construction work. This example includes a series of tasks includes excavation, compaction, concrete pouring, and finishing. However, steps such as a streak arrangement in which an electrical working machine is not used are omitted. In the individual steps, an excavator (a shovel car) is used for the excavation, a compaction machine such as a rammer is used for the compaction, a concrete vibrator is used for the pouring, and a scraper or a trowel is used for the finishing. These working machines are exemplary. In addition to these working machines, there are breakers and lawn mowers for crushing concrete, water sprinklers, blowers, vacuum suction machines, lighting equipment (lights), and the like.

FIG. 1C is a block diagram illustrating an example of a functional configuration of an electrical working machine 110. The drive motor 111 operates with electrical power supplied from a battery 113 and drives a work unit 112. The work unit 112 is a mechanism that generates a unique action according to a type of working machine. A control unit 114 controls an operation of the working machine 110. A communication unit 115 may be optional, and may transmit a state to a computer or the like located in a predetermined management center (for example, a business office of a rental dealer) or the like. In addition, a power switch for switching between starting and stopping of work, limiting an output, and the like may be provided. Here, the battery 113 is of a replaceable type, and the working machine 110 can continue work by a used battery being replaced with a prepared spare battery. The replaced battery can be recharged using a nearby charging station or a rented charger to be reused.

Since power consumption is generally determined according to a type of working machine and its load, a duration of a fully charged battery can be determined according to a model of the working machine on the assumption that the working machine is used with an appropriate load. A time required for a step in which the working machine is used can be generally determined at a stage of planning a schedule of construction in accordance with a construction area and the number of working machines to be used. Conversely, it can be said that a time required for a step is determined in accordance with a construction area and the number of working machines to be used. It is assumed in description of the present embodiment that all the batteries for the working machines are common. However, even when the batteries are not common, the present embodiment can be applied within a range of common working machines of batteries. For example, even when there are a plurality of types of batteries to be shared, the present embodiment may be applied to each group of working machines using each type of battery.

Configuration of Information Processing Apparatus

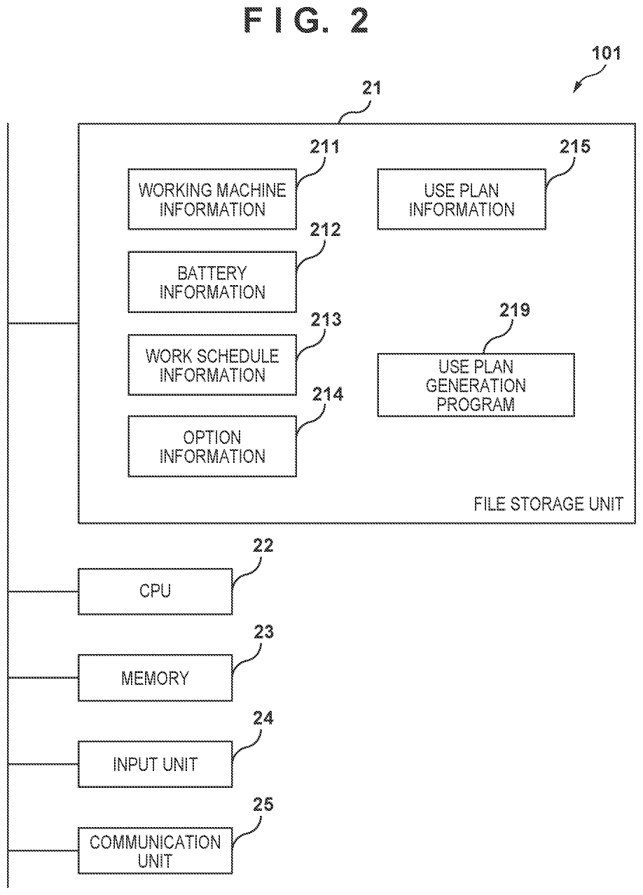

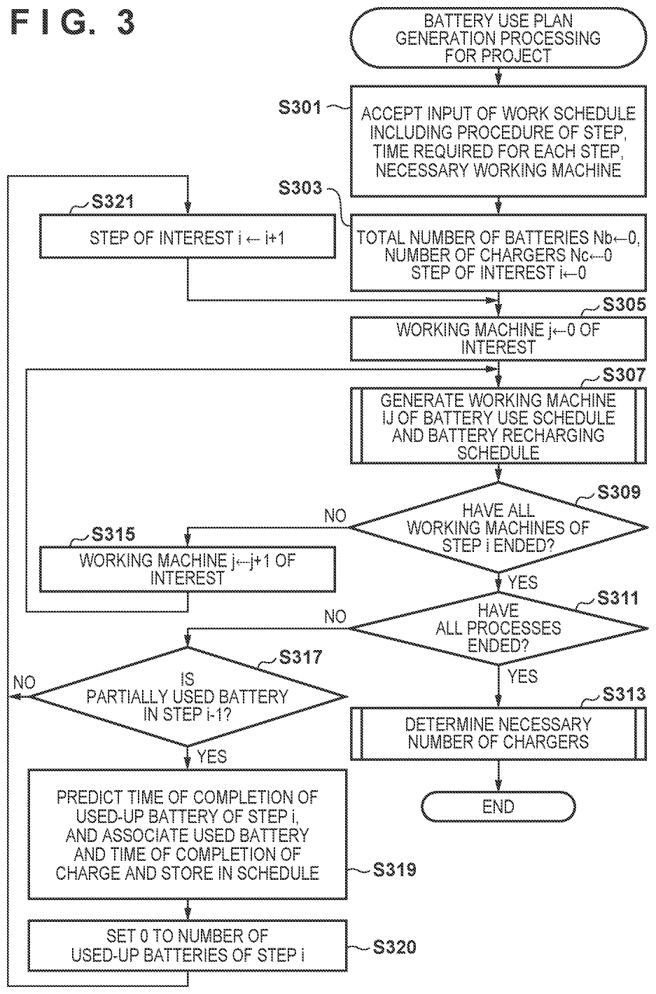

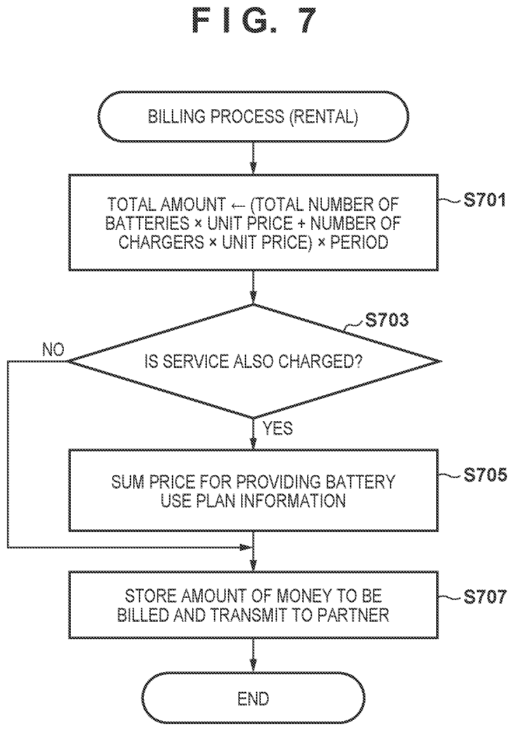

FIG. 2 is a block diagram illustrating an information processing apparatus 101 of a service provider. A file storage unit 21 is, for example, a nonvolatile storage such as a hard disk and stores a data file and a program file. In this example, examples of data include working machine information 211 and battery information 212 that are generated and stored in advance, working schedule information 213 and option information 214 from a building company or a rental company, and use plan information 215 generated by the service provider. As a program, there is a use plan generation program 219 that is executed by the CPU 22 to implement procedures of the flowcharts illustrated in FIGS. 3 to 5 (and FIG. 7 of a modification) to be described below. The CPU 22 loads data and programs to a memory 23 and executes a program to perform data processing and the like. An input unit 24 includes, for example, a keyboard, a pointing apparatus, a touch panel, and the like used by an operator to input information. The communication unit 25 transmits information to an external apparatus, for example, a computer of a rental dealer, or receives data. As described above, the information processing apparatus 101 may be a computer that has a general configuration, but data and programs included therein are unique to the present embodiment.

Next, each piece of data will be described. The working machine information 211 is information for each type of working machine and particularly includes information regarding a battery. For example, the number of batteries required per working machine, the duration of a fully charged battery, and the like are included. The information is determined in advance for each type of working machine and may be information provided by a manufacturer of the working machine.

The battery information 212 is information regarding a battery to be used. For example, the battery information is a time required until an empty battery is fully charged. It is assumed that a time required for charging a non-empty battery can be estimated linearly with respect to a time required from an empty state to full charging. However, when the time required for charging is not linear, a distribution of times required for charging according to a charging state at the start of charging may be included as the battery information 212. The battery information 212 may be information provided by a battery manufacturer. The battery information 212 may further include a rental unit price of the battery and a rental unit price of a charger when the battery is rented.

The working schedule information 213 is schedule information regarding a series of tasks (hereinafter also referred to as a project) using the working machines. A project generally includes a plurality of steps and includes a time required for each step and types and numbers of working machines used in each step. The option information 214 is information selected by a construction company such as a building company, and in this example, includes information (also referred to as priority setting) for generating a battery use plan and selecting either work efficiency priority (efficiency priority) or cost priority (battery number priority). The working schedule information 213 and the option information 214 are input for each project by a construction company or a rental company. The information may be input manually or may be received through communication. Instead of the time required for each step, an amount of power consumed in each step may be used.

The use plan information 215 includes information indicating the generated battery use plan. The battery use plan includes information regarding the number of batteries (the number of chargers in the case of rental), a battery to be mounted for each working machine, a time (timing or time) when a battery is replaced, and a charging start time and a charging end time for each battery. This information may be not only generated and stored as information but also output as display or print sheets to be presented to a rental dealer or a construction company. The use plan information 215 may further include an estimated amount of a budget based on the use plan. The amount of money may be obtained by multiplying the number of batteries to be rented (and the number of chargers in the case of rental) in each rent period and the unit price and calculating a total sum.

Example of Use Plan Information

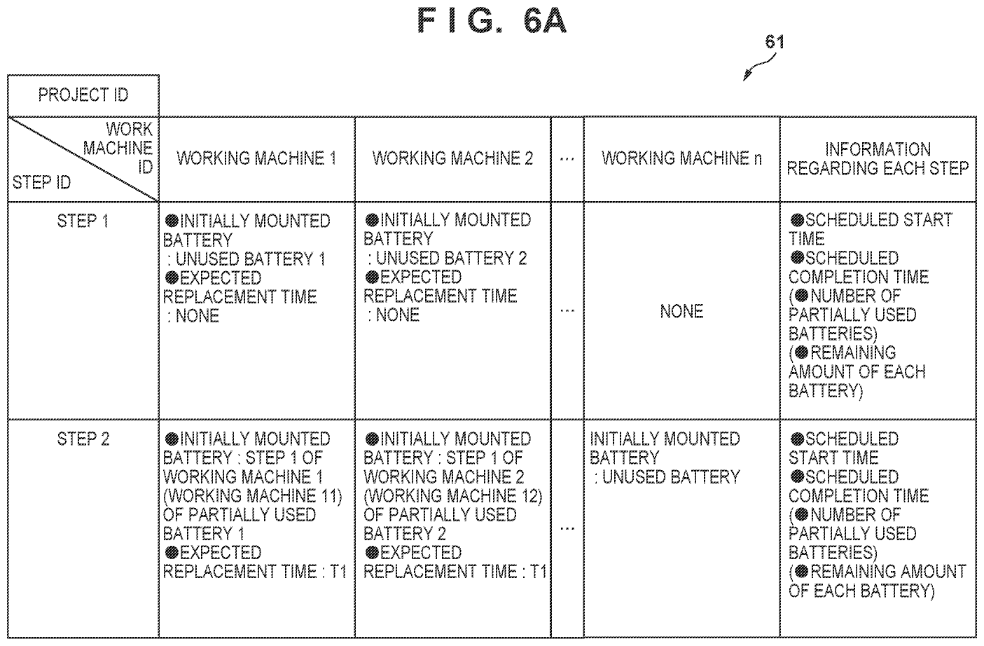

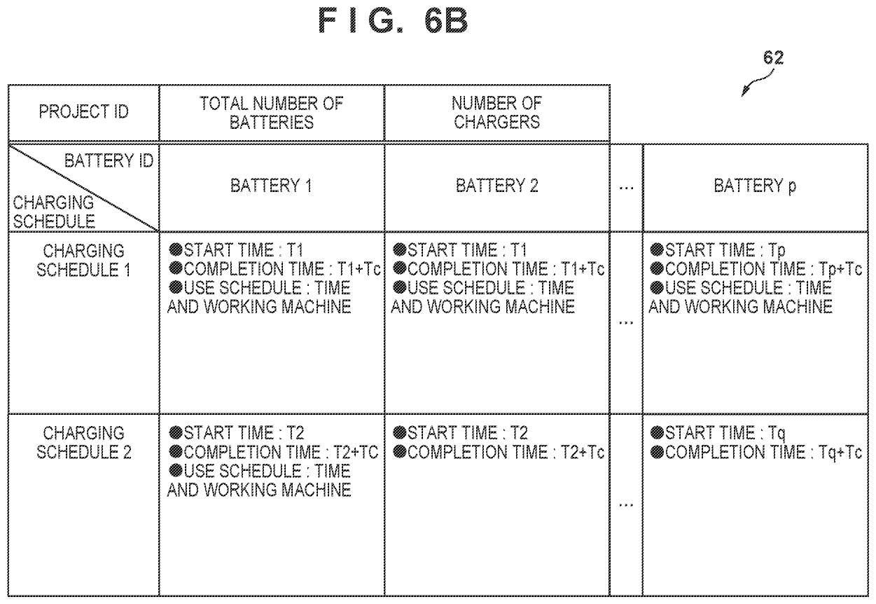

FIGS. 6A and 6B illustrate an example of the use plan information 215. In FIGS. 6A and 6B, the use plan information 215 includes battery use schedule information 61 (see FIG. 6A) and battery recharging schedule information 62 (see FIG. 6B). A project ID is attached to each piece of information. The project ID is unique for each project. The same ID is assigned to the battery use schedule information 61 and the battery recharging schedule information 62 regarding one project. The battery use schedule information 61 includes steps included in the project and a battery use schedule for each working machine in each step. In FIG. 6A, a working machine ID is arranged in the horizontal direction and a step ID is arranged in the vertical direction, and an intersection thereof indicates a use schedule for one working machine in one step. The battery use schedule includes information indicating designation of an initially mounted battery to be mounted at the start of work and an expected replacement time during the work.

As the initially mounted battery, either an unused battery or a recharged battery, or a partially used battery used by the working machine in the previous step is designated. When the partially used battery used by the working machine in the previous step is designated, the step and the ID of the working machine are designated. Here, the unused battery is a fully-charged battery that has not been used in the project of interest. When use of an unused battery is designated in a procedure of FIG. 3 to be described below, the battery needs to be newly rented. That is, a total number of batteries to be rented increases. A recharged battery is a battery that is used in a project of interest and is fully charged, and the total number of batteries to be rented does not change.

The expected exchange time may be an absolute time or may be a relative time based on a time at which a first step of the project starts. Accordingly, there is no influence of a variation at a start time of the first step. In the case of the relative time, for example, a notification of a timing at which the first step starts may be received from a worker or a working machine of the first step, and the time may be used as a reference time. The same applies to other times. When it is not necessary to replace the battery during a step, the expected replacement time is blank. A field of the working machine not used in the step of interest is blank.

Information regarding each step includes a scheduled start time and a scheduled completion time of the step. Such information may be information acquired from a rental dealer or a construction company. Information regarding each step includes the number of partially used batteries and a remaining amount of each battery (which is indicated by a rate with respect to a fully charged state in this example). However, the information is information necessary to generate the battery use plan. The information is changed during a process or become meaningless values in some cases, and thus may not be provided to customers such as rental dealers. The number of partially used batteries is the number of batteries used in the step of interest. When the batteries are used in a next step or charging is scheduled, the number of used batteries is subtracted by the number of used batteries. That is, when the project ends, the number of used batteries is to be zero except for the final step. The remaining amount of each battery is the remaining battery amount used in the step of interest and is used to estimate a time required for charging. The remaining battery amount may be determined, for example, as a ratio of a remaining time (=duration−use time) to a duration of a fully charged battery.

In the battery recharging schedule information 62, the project ID, the total number of batteries, and the number of chargers are recorded, and a charging schedule (a time and/or a required time) for each battery is further recorded. For example, a charging start time (predicted) and an end time (predicted) of the battery are recorded as the charging schedule. The working machine in which the charged battery is used and the use start time thereof are also recorded. In the battery recharging schedule information 62 of FIG. 6B, the horizontal direction indicates a target battery and the vertical direction indicates a recharging schedule of each battery. As described above, the battery use plan information is generated, and a use schedule and a charging schedule of the battery are determined and presented to the customer.

Procedure for Generating Battery Use Plan Information

Before a procedure for generating the battery use plan information is described, various parameters briefly described in FIG. 2 will be described. The input working schedule information 213 includes the following information.

1. Procedure of steps: a step i included in a project is defined and the following information is included for each step.

1.1. Model information of a working machine j used in the step i (referred to as a working machine ij) and the number of necessary working machines. The number of necessary batteries for each model may also be input information, but may be included in the information processing apparatus 101 in advance for each piece of model information.

1.2. Working time twij of the working machine ij in the step i. This may be assumed to be equal to a time required for the step i. In that case, the working time may be the time required for the step i.

Additional necessary information is included in the working machine information 211, the battery information 212, and the option information 214, but individual parameter is defined. These pieces of information are provided from a battery manufacturer or a battery rental dealer.

2.1. The number of mounted batteries nij for each type of working machine.

2.2. Battery duration tdij from full charge of the working machine ij. This duration may be changed between a new battery and a slightly deteriorated battery. For example, a deteriorated battery may be shortened to about 80% of a new battery. To avoid discriminating each battery, a value obtained by multiplying a maximum duration of a new battery by a predetermined ratio (for example, 80%) may be set as the maximum duration for all batteries. By providing a margin to battery performance in this way, it is possible to prevent a deviation in prediction.

2.3. Time tc required for charging from an empty state to a fully charged state of the battery. This may also be a time required for a new battery to absorb an error due to an individual difference between batteries similarly to the duration.

2.4. Priority information indicating efficiency priority or cost priority.

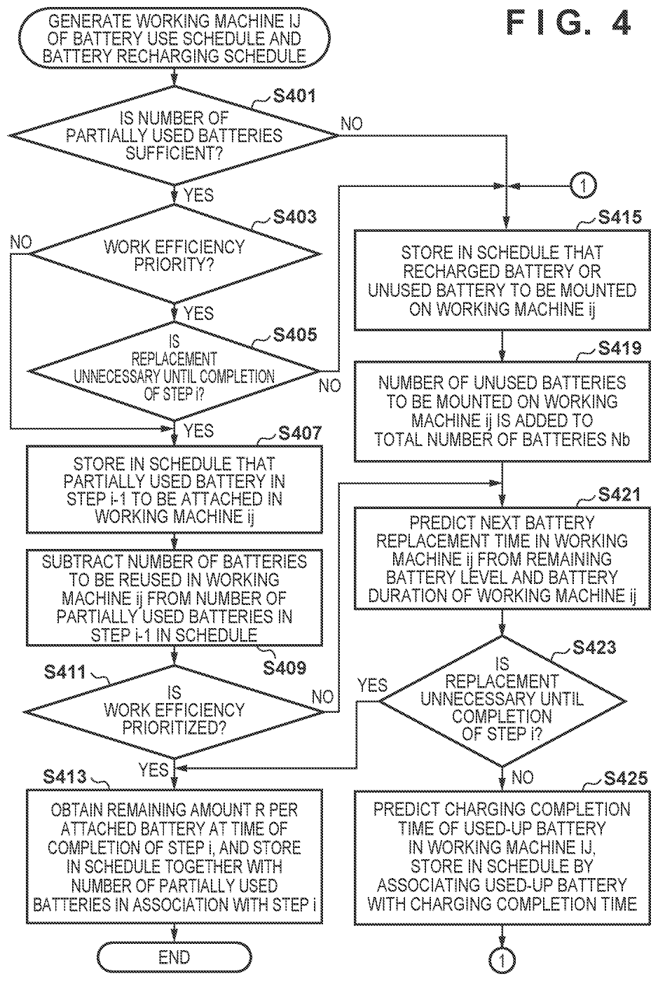

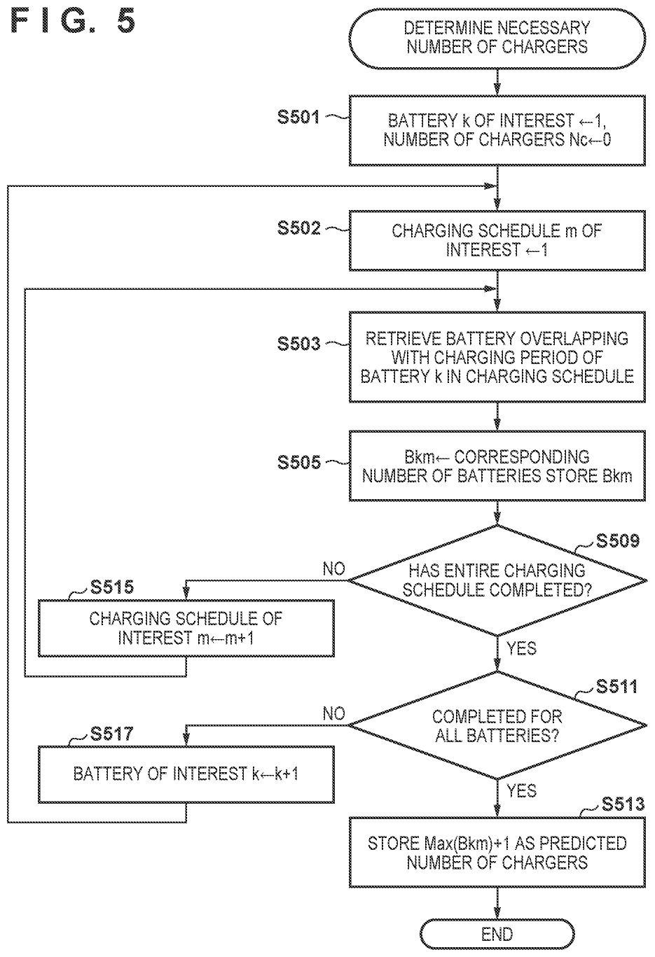

The battery use plan information is generated in the procedure of FIGS. 4 and 5 using the above input information. As described above, this procedure is performed by the CPU 22 of the information processing apparatus 101.

The procedure of FIG. 3 is performed to generate the battery use plan information. First, the procedure of steps, the time required for each step, and the necessary working machine ij are input (S301). Here, the time required for a step corresponds to a working time of each working machine in the step. That is, when the step i is the same, the working time twij by the working machine ij is equal. Of course, when the work time for each individual working machine is input, the work time may be used. In the procedure of the steps, the subscript i indicating the procedure of each step may be determined. Similarly, the subscript j may be sequentially determined for the working machine in each step. ij is an ID for specifying the working machine.

Next, variables are initialized. Specifically, 0 is set in the total number of batteries Nb and the number of chargers Nc, and 1 indicating the first step is set in the step of interest i (S303). Next, in the initialization, continuously, a procedure is given to the working machine j of interest for convenience, and 1 is set in the working machine j of interest first (S305). To simultaneously specify the step and the working machine, the working machine j in the step i is referred to as the working machine ij.

When the initialization is completed, the battery use schedule information 61 and the battery recharging schedule information 62 of the working machine j, that is, the working machine ij in the step of interest i, are generated (S307). This procedure will be described with reference to FIG. 4.

When the battery use schedule information 61 and the battery recharging schedule information 62 are generated for the working machine ij, it is determined whether the process of S307 ends for all the working machines in the step i (S309). When the process ends, that is, when the battery use schedule information 61 and the battery recharging schedule information 62 are generated for all the working machines in the step i, it is determined whether S307 ends for all the steps of the project (S311). When all the steps end, the number of necessary chargers is determined (S313). Then, the process ends. The procedure of S313 will be described with reference to FIG. 5.

Conversely, when any unprocessed working machine remains in the step i in S309, the working machine j of interest is set as a next working machine j+1 of interest (S315). Thereafter, S307 is repeatedly performed on the new working machine of interest. When an unprocessed step remains in S311, it is determined whether the used-up battery in a step i-1 preceding the step of interest i remains (S317). The determination here may be performed with reference to the number of partially used batteries corresponding to the step i-1 in the battery use schedule information 61. If any used-up battery remains in the step i-1 preceding the step of interest i, charging of the used-up battery is scheduled (S319). When there is no preceding step in the step of interest i, the determination result in S317 is negative. In the present embodiment, the battery used in a certain step excluding the final step is used or charged in the next step. Therefore, the charging schedule is set in S319 for the battery that has not been scheduled for charging due to a possibility of being used in the next step. The schedule here is set retroactively so that an end time of the step i-1 is set as the charge start time. Specifically, the time required for charging is predicted based on the remaining amount of the target battery, and the time is added to the charging start time to obtain the charging end time. Then, the obtained charging start time and end time are associated with the target battery and recorded in the battery recharging schedule information 62. Thereafter, the number of partially used batteries in the step i is set to 0 (S320), and the step i of interest proceeds to the next step i+1 and returns to S305. When there is a battery of which a remaining amount is unclear, the time required for charging may be a time required from an empty state to full charging.

According to the foregoing procedure, it is possible to generate the battery use plan information including the number of necessary batteries, the battery use schedule, and the recharge schedule for all the working machines in all the steps. The generated battery use plan information may be transmitted to a computer or the like of a rental dealer, a construction company, or the like or may be provided as a print sheet. The battery use plan information may be used for estimation and billing.

The details of step S307 will be described with reference to FIG. 4. First, it is determined whether the partially used batteries are sufficient (S401). For example, when the number of mounted batteries required in the working machine ij is n, it is determined whether the number of partially used batteries that have been used in a preceding step and have not been recharged is sufficient as n. This determination can be made by comparing the number of partially used batteries corresponding to the step i-1 that is a preceding step included in the battery use schedule information 61 with n. When there is no preceding step, the number of partially used batteries is naturally 0. In the present embodiment, a working machine that uses a plurality of batteries uses batteries that have the same level of remaining amount. Accordingly, an operation in which one battery is set as a partially used battery and one battery is a recharged battery is not performed. That is, the number of partially used batteries determined in S401 is assumed to be batteries that have the same level of remaining amount.

When it is determined that the number of partially used batteries is sufficient, it is determined whether to set work efficiency priority or cost priority with reference to the priority information (S403). In the case of the work efficiency priority, an unused battery or a recharged battery is mounted when each step starts except for a case where it is not necessary to replace the battery meanwhile. In this way, it is possible to prevent a decrease in work efficiency due to a loss of time caused by the battery replacement, a decrease in an operation level of the working machine caused by a decrease in a voltage, or the like. Conversely, in the case of the cost priority, as long as there is a partially used battery in the preceding step, the partially used battery is also used in the step of interest.

When the work efficiency priority is determined to be set in S403, it is determined whether it is necessary to replace the battery until the step of interest i is completed even if the partially used battery is used as it is (S405). In this determination, whether the working machine ij can operate until the completion of the step i with the remaining amount may be determined with reference to the remaining amount of the partially used battery corresponding to the step i-1 which is the preceding step, the time required for the step i, and the battery duration of the working machine ij at the time of full charge included in the battery use schedule information 61. The battery duration may be determined to decrease linearly as the remaining battery amount decreases. For example, when the time twij required for the step i≤the battery duration tdij of the working machine ij×the remaining battery amount (rate) is satisfied, it is determined that replacement is unnecessary.

When it is determined in S403 that the cost priority is set or it is determined in S405 that the replacement is unnecessary, a schedule is generated on the assumption that the partially used battery in the step i-1 is attached to the working machine ij (S407). That is, as the initially mounted battery of the working machine ij in the battery use schedule information 61, the partially used battery of the working machine j (that is, the working machine i-1j) in the step i-1 is recorded. There is a possibility of a plurality of working machines being used in one step. Therefore, in that case, the battery ID may also be recorded to specify the battery.

The partially used battery scheduled to be reused in the step i is determined to be unused by another working machine in the step i, and the battery use schedule information 61 is updated (S409). Specifically, the number of batteries used by the working machine ij is subtracted from the number of partially used batteries in the step i-1. Further, information regarding the remaining battery amount is deleted for the battery used in the working machine ij.

Next, the priority information is tested again to determine whether work efficiency is prioritized (S411). In the case of the work efficiency priority, information regarding the battery of the working machine ij when the step i is completed is recorded in the battery use schedule information 61. Specifically, a remaining amount per battery used by the working machine ij is obtained. Then, for the step i, for example, the remaining amount is recorded in association with the battery ID, and the number of batteries assumed to be used by the working machine ij is added to the number of partially used batteries in the step i. Here, the process of FIG. 4 ends.

Conversely, when it is determined in S401 that the number of partially used batteries is not sufficient for the working machine ij or when it is determined in S405 that the partially used battery is used and a battery is not sufficient until the completion of the step i, the process branches to S415. Here, a recharged battery or an unused battery is scheduled to be mounted on the working machine ij. However, when there is a recharged battery, the recharged battery is preferentially scheduled (S415). Specifically, with reference to the battery recharging schedule information 62, the battery of which a charging completion time is earlier than the start time of the step i and of which a use schedule is not recorded is the recharged battery available in the step i. When there is a corresponding battery, the corresponding battery is recorded in the battery use schedule information 61 as an initially mounted battery of the working machine ij. Further, with regard to the corresponding battery, the scheduled use time and an ID of the working machine ij are recorded in the battery recharging schedule information 62. When the available recharging batteries are insufficient, the unused battery is recorded as an initially mounted battery of the working machine ij in the battery use schedule information 61.

Next, the number of unused batteries among the batteries mounted on the working machine ij is added to the total number of batteries Nb (S419). The final number of unused batteries is the number of batteries to be rented.

For the battery scheduled to be mounted on the working machine ij in S415, a next battery replacement time is calculated from the remaining amount, the battery duration tdij of the working machine ij, and the time Ti required for the step i (S421). For example, the battery replacement time may be obtained by adding the battery duration tdij×the remaining amount (%) to the start time of the step i.

When the battery replacement time is predicted, it is determined whether the predicted battery replacement time is later than the completion time of step i, that is, whether replacement of the battery is unnecessary until the completion of the step i (S423). If the replacement of the battery is unnecessary, the process branches to S425, and the remaining battery amount of the working machine ij at the time of completion of the step i is obtained and recorded in the battery use schedule information 61.

Conversely, when it is determined that the battery needs to be replaced during the step i in S423, recharging of the used-up battery to be replaced in the working machine ij is scheduled (S425). In the schedule here, the battery replacement time predicted in S421 is set as the charge start time, and a time required for charging from the empty state to the full charge is added to that time to set a charge end time. Then, the obtained charging start time and end time are associated with the target battery and recorded in the battery recharging schedule information 62. Thereafter, the process branches to S415 to schedule a use plan for the battery to be reattached to the working machine ij.

Through the foregoing procedure, the battery use plan information for one project is generated. In the foregoing procedure, when the cost priority is designated as the priority information, the battery is used as much as possible until replacement is required, and thus the total number can be inhibited. Conversely, in the case of the work efficiency priority, a fully charged battery is used when each step starts. Therefore, the number of times of battery replacement can be inhibited, and deterioration in performance of the working machine can be inhibited. The generated battery use plan information includes designation of a battery to be mounted on each working machine, an expected replacement time, a charging start time and an end time of the battery, a use schedule of the recharged battery, and the total number of batteries to be prepared. Based on the information, the number of chargers Nc required is determined in the procedure of FIG. 5.

Determination of the Number of Chargers

In FIG. 5, a battery number k of interest is set to 1 for initialization, and the number of chargers Nc is initialized to 0 (S501). A charging schedule number m of interest is set to 1 for initialization (S502). The battery number of interest and the charging schedule number of interest are numbers for designating a field of a charging schedule specified with the battery and the schedule in the battery recharging schedule information 62.

Next, another battery overlapping with the charging period of the battery k of interest in the charging schedule m of interest is retrieved from the battery recharging schedule information 62 (S503). Here, one charging period of the battery of interest is focused on to obtain the number of batteries of which a charging period overlaps with that period. To charge one battery, the number of chargers may be one no matter how there are many opportunities for charging. Accordingly, for one battery, it is sufficient to count 1 at maximum. The corresponding number of batteries Bkm thus obtained in this way is stored (S505).

Next, it is determined whether the process has been completed by focusing on the entire charging schedule in the battery recharging schedule information 62 (S509). When the process has not been completed, the charging schedule of interest is moved to a next battery (S515). Then, the process is repeated from S503. When the process has been completed, it is determined whether the process has been completed by focusing on all the batteries in the battery recharging schedule information 62 (S511). When the process has not been completed, the battery of interest is moved to a next battery (S517). Then, the process is repeated from S502. In this way, the number of batteries other than the battery of interest of which the charging schedules overlap with the battery number and the charging schedule number in the battery recharging schedule information 62 is obtained and stored for all the fields of the charging schedule specified with the battery number and the charging schedule number in the battery recharging schedule information. When there is no charging schedule in a field of interest, the process may be skipped for the field and the next field may be focused on.

Finally, a value obtained by adding 1 to the maximum Bkm value among the stored k×m (maximum) Bkm is recorded in the battery recharging schedule information 62 as the predicted number of necessary chargers. As described above, in the present embodiment, the value obtained by adding the value of 1 for a reference charging period to the maximum value of the number of batteries charged in parallel in one charging period is determined as the number of chargers. That is, the charging schedule time is arranged on the time axis, and the number of charging schedules in a season of the largest overlapping corresponds to the number of necessary chargers.

The battery use plan information illustrated in FIGS. 6A and 6B is obtained in the procedure described with reference to FIGS. 3 to 5. This information may be kept in this table, but can be seen more easily by converting various events described in the table into a graphical format arranged along a time axis. By providing such information to the customer, a service provider obtains a reward. The provided information may be limited to information designated by a customer such as a construction company. The format of the information may also be a format designated by the customer. In addition, the rental dealer pays for the equipment rental. In the following description, the term billing is used. However, in use planning, it may be said that the rental is not billed but estimated as used so far. The use plan generation service may be literally billed.

Billing Process

FIG. 7 illustrates an example of a procedure for a rental price billing process (or estimation process). In this procedure, a total amount is first obtained by multiplying, by a rental period, a value obtained by multiplying the total number of batteries to be rented by a rental unit price of the battery (fee/unit period, one battery) and a value obtained by adding a value obtained by multiplying the number of chargers by the rental unit price of the charger in a case where the charger is also rented (S701). Since the number of batteries is reflected in this total amount, in other words, setting of priority information, that is, the work efficiency priority or the cost priority, is reflected. Then, it is determined whether a fee of a service for providing the battery use plan information is also added (S703). As a determination reference of S703, there can be reference which are not various. For example, when the rental dealer provides the service, it may be determined that conditions of S703 is satisfied. When the rental dealer provides a service and the service is a flat-rate service, it may be determined that the service does not satisfy the conditions of S703. In this way, it is determined in S703 whether to add a rental fee and a service provision fee.

When the price of the service is also added up, a price for providing the battery use plan information is added to the total amount obtained in S701 (S705). The amount of money obtained in this way (an amount of money to be billed or an amount of money to be estimated) is stored in association with information regarding a partner and is transmitted to the partner (S707). In this transmission, the generated battery use plan information may be transmitted together.

In the present embodiment, a use time of the unused battery can be known from the battery use schedule information 61. Therefore, it is possible to specify a time at which the unused battery is necessary. Accordingly, even when all the necessary batteries in the start of the project are not provided, it is possible to provide the construction company with an amount necessary at the time at which the unused battery is necessary (for example, a start time of the step) in accordance with the battery use schedule information 61. The same applies to a charger of which a charging timing can be specified from the battery recharging schedule information 62. Therefore, it is possible to further shorten a rental period of a rental apparatus such as a battery and a charger. Further, when renting is usually performed in a plurality of construction companies, it is also possible to inhibit the number of rental apparatuses prepared by the rental companies.

### EXAMPLES

Specific examples will be described below.

A building company requests a rental dealer to rent a battery and a charger. At that time, the building company notifies the rental company of the following content as content of a working schedule. The content to be conveyed is the following information.

Working Schedule Content
In the morning, two rammers (consolidation machines) are used in a work site A. Each of the rammers is used 10 minutes/time×2 times.
Thereafter, movement to a work site B in the afternoon is performed, and one shovel car and one balloon type light are used in the work site B. The shovel car is used 30 minutes×2 times and the balloon light is used 30 minutes×1 time.
Output necessary for each working machine. Alternatively, the output of each working machine may be calculated based on advance data.

The rental dealer inputs the working schedule contents to a personal computer. Based on the input content, the personal computer generates a use plan in which the number of necessary batteries is two, the number of chargers is one, one battery between the two batteries is fully charged after end of morning work and used for the shovel car in the afternoon, and the one remaining battery is used for the balloon light in the afternoon without being charged. This use plan is generated by the procedure of FIGS. 3 to 5. When a plan for unnecessary charging is generated, it is not necessary to rent a charger. The personal computer of the rental dealer stores in advance the following battery duration and time required for charging provided by a battery manufacturer. For example, the battery can output 1 kW or more for 30 minutes in a fully charged state, and the battery can be charged from 0% to 100% in 90 minutes in the information.

The rental dealer rents a battery or the like to the building company based on the use plan.

### Advantageous Effects of Present Embodiment

In the above-described present embodiment, it is possible to provide a highly accurate battery use plan. Accordingly, it possible to prepare and rent an appropriate number of rental apparatuses, for example, batteries and chargers without excess or deficiency. Further, by designating the priority information, it is possible to generate a plan in accordance with whether the work efficiency priority and the cost priority is set. Further, since the generated information is also information indicating a temporal transition of the number of necessary rental apparatuses such as batteries and chargers, arrangement of the apparatuses can be made more flexible, and it is useful to reduce the rental cost. By providing a useful battery use plan in this way, it is also possible to realize the providing work as a profit business.

### Modification

A building company inputs the following content as content of a working schedule into a personal computer owned by the building company. That is, in the present modification, the construction company generates a battery use plan information by itself. However, the computer of the construction company performs a process, or by a web application provided on a cloud may perform the process.

Working Schedule Content

In the morning, two rammers (consolidation machines) are used in the work site A. Each of the rammers is used 10 minutes/time×2 times.

Thereafter, movement to a work site B in the afternoon is performed, and one shovel car and one balloon type light are used in the work site B. The shovel car is used 30 minutes×2 times and the balloon light is used 30 minutes×1 time. (an output necessary for each working machine is input as necessary)

Based on the input content, the personal computer of the building company generates a use plan in which two batteries are required, one charger is used for the excavator in the afternoon by fully charging one of the two batteries after the end of the morning work, and the one remaining battery is used for the balloon light in the afternoon without charging.

(When a plan for unnecessary charging is generated, it is not necessary to rent a charger)

The personal computer stores in advance the following battery duration and time required for charging provided by a battery manufacturer.

The battery can output 1 kW or more for 30 minutes in a fully charged state, and the battery can be charged from 0% to 100% in 90 minutes.

The building company generates a work plan based on the use plan generated in this way.

### Modification 2

A building company performs work based on a work plan generated based on a use plan generated based on the content described in the foregoing embodiment or modification. During the work, at least information regarding the remaining amount may be periodically or constantly transmitted from a battery to a personal computer of the building company. The personal computer may display a difference occurring in the use plan based on the remaining amount. Accordingly, the building company can ascertain a difference from the use plan at an early stage based on a usage beyond expectation, and can review the work plan.

At least the information regarding the remaining amount may be transmitted to the personal computer of the rental dealer, and the personal computer of the rental dealer may display a difference occurring in the use plan based on the remaining amount. Accordingly, the rental dealer can ascertain a difference from the use plan at an early stage based on a usage beyond expectation, and can plan preparation or provision of an additional battery.

At least the information regarding the remaining amount may be transmitted to a personal computer of a battery manufacturer. Accordingly, the battery manufacturer can reflect the use plan of the system in a design review or detect abnormality (a failure) of the battery based on the usage beyond expectation.

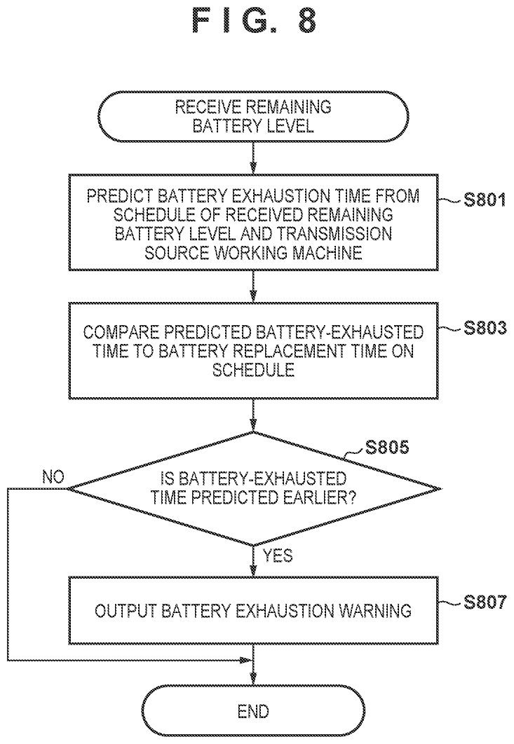

FIG. 8 illustrates an example of a processing procedure by the working machine according to the present modification. This procedure is performed by the CPU 22 in accordance with remaining battery amount information received from the working machine. First, a battery-exhausted time is predicted from the received remaining battery amount and the schedule of the working machine of a transmission source. It is assumed that the working machine which is the transmission source can be specified from information such as an address of a transmitter. When the working machine is specified, a battery duration can also be specified. Thus, the battery-exhausted time, that is, the battery replacement time, can be predicted from the battery duration and a current remaining battery amount.

Next, the predicted battery-exhausted time is compared with the battery replacement time of the working machine on the schedule (S803). The working machine in which battery replacement is not scheduled may be compared with an end time of the step. Then, it is determined whether the battery-exhausted time predicted in the comparison result of S801 is earlier (S805). When the predicted battery-exhausted time is earlier, a battery exhaustion warning is output (S807). An output destination of this warning may be a transmission destination registered in advance. For example, the output destination may be a working machine of the transmission source of the remaining battery amount, a computer of a construction company, a computer of a rental company, or the like. Display may be output on a terminal of a service provider.

### Advantageous Effects of Modification 2

According to Modification 2, in addition to the advantageous effects of the embodiment, it is possible to notify an administrator or a worker of a difference in an actual operation as compared with the schedule. In particular, necessary description can be arranged in advance by notifying the difference when apparatuses more than the plan, for example, batteries, are necessary.

### Summary of Embodiment

(1) According to the first aspect of the present invention, there is provided an information processing apparatus that generates battery use plan information of batteries for performing each step included in a series of tasks by electrical working machines capable of sharing batteries, the information processing apparatus characterized by comprising:

storage means for storing a number of batteries to be used for each type of the working machine, a battery duration for each type of the working machine, and a time required for charging the battery;

input means for receiving, as input information, a working schedule including a procedure of the steps, a time required for each of the steps or a power amount required for each of the steps, and types and numbers of working machines used in each of the steps; and generation means for generating, based on the input information, use plan information of batteries including the number of the batteries required for the series of tasks and charging timings of the batteries.

In this configuration, the appropriate battery use plan information can be generated, and battery use efficiency and cost reduction can be achieved.

(2) According to the second aspect of the present invention, there is provided the information processing apparatus according to article 1, characterized in that the generation means determines a predicted number of chargers conforming to the use plan information based on the use plan information.

In this configuration, it is possible to generate the appropriate use plan information for not only the battery but also the charger.

(3) According to the third aspect of the present invention, there is provided the information processing apparatus according to article 1, characterized in that the generation means further generates information indicating a temporal transition of the number of necessary batteries.

In this configuration, it is possible to ascertain the temporal transition of the number of batteries and the number of chargers and use the batteries and the chargers more efficiently.

(4) According to the fourth aspect of the present invention, there is provided the information processing apparatus according to any one of articles 1 to 3, characterized in that

the generation means determines whether or not a partially used battery used in a step preceding a step of interest is usable as a battery to be used in the step of interest, and when the partially used battery is not usable, the generation means generates the use plan information using a new battery in the step of interest.

In this configuration, it is possible to efficiently use the battery by scheduling the battery with reference to availability of the partially used battery in the preceding step for each step.

(5) According to the fifth aspect of the present invention, there is provided the information processing apparatus according to article 4, characterized in that

the generation means generates the use plan information using a total number of new batteries to be used in the step of interest over the series of tasks as the number of necessary batteries.

In this configuration, it is possible to know the total number of batteries required in the battery use plan information and to be provided, and therefore it is possible to provide accurate batteries.

(6) According to the sixth aspect of the present invention, there is provided the information processing apparatus according to any one of articles 1 to 5, characterized in that

the generation means determines whether or not a step of interest is completable even when the partially used battery used in the step preceding the step of interest is used as it is as the battery to be used in the step of interest, and when the step of interest is completable, the generation means generates the use plan information using the partially used battery as it is in the step of interest.

In this configuration, by sparsely using the battery used in the preceding step, it is possible to use the battery more efficiently.

(7) According to the seventh aspect of the present invention, there is provided the information processing apparatus according to any one of articles 1 to 6, characterized in that

the generation means determines whether or not the partially used battery used in the step preceding the step of interest is usable as the battery used in the step of interest and whether or not charging of the battery is completable by the step of interest, and in a case where the charging is completable, the generation means starts recharging the partially used battery when the preceding step is completed, and generates the use plan information using the recharged battery in the step of interest.

In this configuration, a time of recharging the battery can be scheduled, and more efficient use of the battery in recharging can be achieved.

(8) According to the eighth aspect of the present invention, there is provided the information processing apparatus according to article 1, characterized in that

the input means further receives priority setting regarding whether priority is given to battery number priority for reducing the number of necessary batteries or efficiency priority for reducing the number of battery replacements, and

in accordance with the priority setting, the generation means generates the use plan information using a partially used battery used in a step preceding the step of interest as it is as a battery to be used in the step of interest in a case where priority is given to the number of batteries, and using a charged battery as a battery to be used in the step of interest in a case where priority is given to efficiency.

In this configuration, efficiency priority and cost priority can be designated, and thus it is possible to generate a battery use plan according to the designation.

(9) According to the ninth aspect of the present invention, there is provided an information processing apparatus that estimates a rental fee of batteries for performing each step included in a series of tasks by electrical working machines that share batteries, the information processing apparatus characterized by comprising:

storage means for storing a number of batteries to be used for each type of the working machine, a battery duration for each type of the working machine, a time required for charging the battery, and a rental unit price of the battery; and

input means for receiving, as input information, a working schedule including a procedure of the respective steps, a time required for the respective steps or a power amount required for the respective steps, and a type and a number of the working machines used in the respective steps; and

generation means for determining the number of batteries required for the series of tasks based on the input information, and generating estimation information of the rental fee based on the number of batteries and the rental unit price.

In this configuration, it is possible to generate an estimate of the amount of rent for improving the battery use efficiency and reducing the cost.

(10) According to the tenth aspect of the present invention, there is provided the information processing apparatus according to article 9, characterized in that

the input means further receives priority setting as to whether priority is given to battery number priority for reducing the number of necessary batteries or efficiency priority for reducing the number of battery replacements, and

in accordance with the priority setting, in a case of the battery number priority, the generation means generates use plan information using a partially used battery used in the step preceding the step of interest as it is as a battery to be used in the step of interest, and in a case of the efficiency priority, the generation means generates use plan information using a charged battery as a battery to be used in the step of interest, and generates estimation information of a rental fee based on the use plan information.

In this configuration, the efficiency priority and the cost priority can be designated, and thus it is possible to generate an estimate according to the designation.

(11) According to the eleventh aspect of the present invention, there is provided the information processing apparatus according to article 10, characterized in that

the generation means further generates the estimation information by adding a price for providing the use plan information to the rental fee.

In this configuration, in addition to the rental fee, a price for generating the battery use plan can also be billed.

(12) According to the twelves aspect of the present invention, there is provided a computer program that generates battery use plan information for performing each step included in a series of tasks by electrical working machines that share batteries, the computer program causing a computer to function as:

storage means for storing a number of batteries used for each type of the working machine, a battery duration for each type of the working machine, and a time required for charging the battery;

input means for receiving, as input information, a working schedule including a procedure of the steps, a time required for each of the steps, and types and numbers of working machines used in each of the steps; and

generation means for generating, based on the input information, battery use plan information including the number of the batteries required for the series of tasks and charging timings of the batteries.

In this configuration, it is possible to generate the appropriate battery use plan information using a computer and it is possible to realize the battery use efficiency and the cost reduction.

(13) According to the thirteenth aspect of the present invention, there is provided a computer program that estimates a rental fee of batteries performing each step included in a series of tasks by electrical working machines that share batteries, the computer program causing a computer to function as:

storage means for storing the number of batteries used for each type of the working machine, a battery duration for each type of the working machine, a time required for charging the battery, and a rental unit price of the battery; and

input means for receiving, as input information, a working schedule including a procedure of the steps, a time required for each of the steps or a power amount required for each of the steps, and types and numbers of working machines used in each of the steps; and

generation means for determining the number of batteries required for the series of tasks based on the input information and generating estimation information of the rental fee based on the number of batteries and the rental unit price.

In this configuration, it is possible to generate an estimate of the rental fee for achieving the battery use efficiency and cost reduction using a computer.

The invention is not limited to the foregoing embodiments, and various variations/changes are possible within the spirit of the invention.

What is claimed is:

1. An information processing apparatus that generates use plan information of batteries for performing each step included in a series of tasks by electrical working machines capable of sharing batteries, the information processing apparatus comprising:
at least one memory which stores at least one program; and
at least one processor, wherein the at least one program causes the at least one processor to perform:
storing a number of batteries to be used for each type of the working machine, a battery duration for each type of the working machine, and a time required for charging the battery;
receiving, as input information, a working schedule including a procedure of the steps, a time required for each of the steps or a power amount required for each of the steps, and types and numbers of working machines used in each of the steps; and
generating, based on the input information, use plan information of batteries including the number of the batteries required for the series of tasks and charging timings of the batteries.

2. The information processing apparatus according to claim 1, wherein
the generating determines a predicted number of chargers conforming to the use plan information based on the use plan information.

3. The information processing apparatus according to claim 1, wherein
the generating further generates information indicating a temporal transition of the number of necessary batteries.

4. The information processing apparatus according to claim 1, wherein
the generating determines whether or not a partially used battery used in a step preceding a step of interest is usable as a battery to be used in the step of interest, and when the partially used battery is not usable, the generating generates the use plan information using a new battery in the step of interest.

5. The information processing apparatus according to claim 4, wherein
the generating generates the use plan information using a total number of new batteries to be used in the step of interest over the series of tasks as the number of necessary batteries.

6. The information processing apparatus according to claim 1, wherein
the generating determines whether or not a step of interest is completable even when the partially used battery used in the step preceding the step of interest is used as it is as the battery to be used in the step of interest, and when the step of interest is completable, the generating generates the use plan information using the partially used battery as it is in the step of interest.

7. The information processing apparatus according to claim 1, wherein
the generating determines whether or not the partially used battery used in the step preceding the step of interest is usable as the battery used in the step of interest and whether or not charging of the battery is completable by the step of interest, and in a case where the charging is completable, the generating starts recharging the partially used battery when the preceding step is completed, and generates the use plan information using the recharged battery in the step of interest.

8. The information processing apparatus according to claim 1, wherein
the receiving further receives priority setting regarding whether priority is given to battery number priority for reducing the number of necessary batteries or efficiency priority for reducing the number of battery replacements, and
in accordance with the priority setting, the generating generates the use plan information using a partially used battery used in a step preceding the step of interest as it is as a battery to be used in the step of interest in a case where priority is given to the number of batteries, and using a charged battery as a battery to be used in the step of interest in a case where priority is given to efficiency.

9. An information processing apparatus that estimates a rental fee of batteries for performing each step included in a series of tasks by electrical working machines that share batteries, the information processing apparatus comprising:
at least one memory which stores at least one program; and
at least one processor, wherein the at least one program causes the at least one processor to perform:
storing a number of batteries to be used for each type of the working machine, a battery duration for each type of the working machine, a time required for charging the battery, and a rental unit price of the battery; and
receiving, as input information, a working schedule including a procedure of the respective steps, a time required for the respective steps or a power amount required for the respective steps, and a type and a number of the working machines used in the respective steps; and
determining the number of batteries required for the series of tasks based on the input information, and generating estimation information of the rental fee based on the number of batteries and the rental unit price.

10. The information processing apparatus according to claim 9, wherein
the receiving further receives priority setting as to whether priority is given to battery number priority for reducing the number of necessary batteries or efficiency priority for reducing the number of battery replacements, and
in accordance with the priority setting, in a case of the battery number priority, the generating generates use plan information using a partially used battery used in the step preceding the step of interest as it is as a battery to be used in the step of interest, and in a case of the efficiency priority, the generating generates use plan information using a charged battery as a battery to be used in the step of interest, and generates estimation information of a rental fee based on the use plan information.

11. The information processing apparatus according to claim 10, wherein
the generating further generates the estimation information by adding a price for providing the use plan information to the rental fee.
A non-transitory computer-readable storage medium storing a computer program which, when loaded into a computer and executed, causes the computer to perform an information processing method, the method comprising:

12. A non-transitory computer-readable storage medium which stores a computer program which, when loaded into a computer and executed, causes the computer to perform an information processing method for generating battery use plan information for performing each step included in a series of tasks by electrical working machines that share batteries, the method comprising:
storing a number of batteries used for each type of the working machine, a battery duration for each type of the working machine, and a time required for charging the battery;
receiving, as input information, a working schedule including a procedure of the steps, a time required for each of the steps, and types and numbers of working machines used in each of the steps; and
generating, based on the input information, battery use plan information including the number of the batteries required for the series of tasks and charging timings of the batteries.

13. A non-transitory computer-readable storage medium which stores a computer program which, when loaded into a computer and executed, causes the computer to perform an information processing method for estimating a rental fee of batteries performing each step included in a series of tasks by electrical working machines that share batteries, the method comprising:
storing the number of batteries used for each type of the working machine, a battery duration for each type of the working machine, a time required for charging the battery, and a rental unit price of the battery; and
receiving, as input information, a working schedule including a procedure of the steps, a time required for each of the steps or a power amount required for each of the steps, and types and numbers of working machines used in each of the steps; and
determining the number of batteries required for the series of tasks based on the input information and generating estimation information of the rental fee based on the number of batteries and the rental unit price.
